(19) United States
(12) Patent Application Publication
(10) Pub. No.: US 2022/0386657 A1
(43) Pub. Date: Dec. 8, 2022

(54) FOOD ITEM AND METHOD FOR MANUFACTURING SAME

(71) Applicant: Ohayo Dairy Products Co., Ltd., Okayama-shi Okayama (JP)

(72) Inventor: Ryo IMAMIYA, Okayama-shi Okayama (JP)

(21) Appl. No.: 17/886,760

(22) Filed: Aug. 12, 2022

Related U.S. Application Data
(63) Continuation of application No. 16/468,099, filed on Jun. 10, 2019, now abandoned.

(30) Foreign Application Priority Data
Dec. 12, 2016 (JP) 2016-240367

(51) Int. Cl. A23L 5/10; A23L 9/10; A23G 1/30; A23G 3/32; A23G 9/32

(52) U.S. Cl. CPC A23L 5/10; A23L 9/10; A23G 1/30; A23G 3/32; A23G 9/32; A23V 2002/00

(57) ABSTRACT

There is provided a food item capable of maintaining the good crispy texture of the caramelized portion for a long period of time. A surface-baked food item is characterized by including a first food item, and a second food item containing fat and oil, wherein part or all of the surface of the second food item is coated with a heated product of sugar. Furthermore, the second food item is preferably at least one type or two types or more food items selected from the food item group consisting of chocolates and fats and oils.

### CROSS-REFERENCE TO RELATED APPLICATIONS

This Application is a Continuation of U.S. patent application Ser. No. 16/468,099, filed Jun. 10, 2019, entitled SURFACE-BAKED FOOD ITEM AND METHOD FOR MANUFACTURING SAME, which application is a U.S. National Phase Entry under 35 U.S.C. § 371 of and claims priority to International Application No. PCT/JP2017/037410, filed Oct. 16, 2017, entitled SURFACE-BAKED FOOD ITEM AND METHOD FOR MANUFACTURING SAME, which claims priority to Japanese Patent Application No. 2016-240367, filed Dec. 12, 2016, the entirety of each of which is incorporated herein by reference.

### GOVERNMENT RIGHTS STATEMENT

N/A.

### FIELD

The present invention relates to a surface-baked food item and a method for manufacturing the same.

### BACKGROUND

A method has heretofore been known in which sugar is sprinkled on the surface of food items such as pudding, crème brulee, custard pudding, ice cream, other western confectionery and baked confectionery, and bread, and is heated to caramelize the sugar attached to the surface of the food items to achieve a crispy texture and a unique savory flavor.

Further, from the viewpoint of convenience for eating and food distribution, manufactured food items are packaged in various ways before distributed. For example, Patent Literature 1 discloses a method by which the surfaces of food items contained in containers are continuously baked while the containers are prevented from being thermally deformed.

### SUMMARY

### Technical Problem

However, caramel is likely to absorb moisture, and therefore easily becomes sticky due to the moisture of food items themselves and moisture in the air, so that its good crispy texture and savory flavor just after heating are not maintained.

Therefore, even when food items with caramelized surface are manufactured, their good crispy texture is lost when the food items are distributed after manufacturing, which is disadvantageous in that customers who buy the food items cannot enjoy such a good texture.

### Solution to Problem

In view of such a problem, the present invention is provided with the following features.

(1) A surface-baked food item according to the present invention is characterized by including a first food item, and a second food item containing fat and oil, wherein part or all of a surface of the second food item is coated with a heated product of sugar.

(2) In (1) described above, it is characterized in that at least part of a surface of the first food item is coated with the second food item.

(3) It is characterized in that the second food item is at least one type or two types or more food items selected from the food item group consisting of chocolates and fats and oils.

(4) It is characterized in that the first food item is at least one type or two types or more food items selected from the food item group consisting of pudding, crème brulee, custard pudding, ice cream, cake, other western unbaked confectionery, “iced milk” (ice cream with a milk solids content of 10% or more and a milk fat content of 3% or more), “lacto-ice” (ice cream with a milk solids content of 3% or more), sherbet, other baked confectionery, cheese, yogurt, pasta, meat, and bread.

(5) It is characterized in that the second food item is placed so as to coat a surface of the first food item filled in a container having an opening, the surface being located on an opening side of the container.

(6) A method for manufacturing a surface-baked food item according to the present invention is a method for manufacturing a surface-based food including a first food item and a second food item that coats at least part of a surface of the first food item and contains fat and oil, the method characterized by comprising the step of heating sugar attached to a surface of the second food item to obtain a heated product of sugar.

(7) It is characterized in that the heated product of sugar in the method for manufacturing a surface-baked food item according to the present invention is obtained by caramelizing the sugar by heating.

### BRIEF DESCRIPTION OF THE DRAWINGS

FIG. 1 is a schematic cross-sectional view of a food item according to the present invention contained in a container.

### DETAILED DESCRIPTION

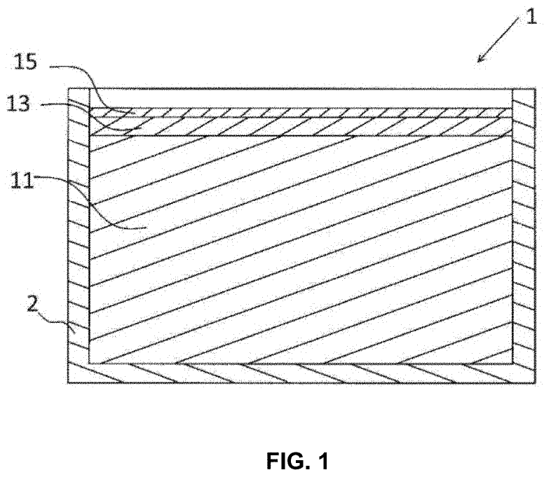

Hereinbelow, the present invention will be specifically described. FIG. 1 is a schematic cross-sectional view of a food item contained in a container. A food item 1 according to the present invention is provided to be contained in a container 2 in such a manner that the surface of a first food item 11 is coated with a second food item 13, and becomes a state in which a caramel portion 15 is further provided on the surface of the second food item 13. Note that an embodiment that will be described below includes a heated product obtained by caramelization, and therefore the heated product is referred to as a “caramel portion,” but when a heated product obtained not by caramelization is used, the “caramel portion” can be replaced with “heated product” as an alternative meaning.

The first food item 11 is a main food item to be subjected to caramelization. Examples thereof may include western unbaked confectionery such as pudding, crème brulee, custard pudding, and cake, ice cream, “iced milk” (ice cream with a milk solids content of 10% or more and a milk fat content of 3% or more), “lacto-ice” (ice cream with a milk solids content of 3% or more), sherbet, other baked confectionery, cheese, and yogurt. Alternatively, the first food item 11 may be pasta, meat, bread, or a cookie.

The second food item 13 contains fat and oil. Particularly suitable examples thereof may include chocolates such as chocolate, “quasi chocolate” (quasi chocolate refers to a dough containing only a quasi-chocolate dough with a cacao content of not less than 15% of the total weight (cocoa butter content of not less than 3% of the total weight), a fat content of not less than 18% of the total weight, and a moisture content of not more than 3% of the total weight (excluding those falling under the category of chocolate dough) or refers to a dough containing only a quasi-chocolate dough with a cacao content of not less than 7% of the total weight (cocoa butter content of not less than 3% of the total weight), a fat content of not less than 18% of the total weight, a milk solids content of not less than 12.5% of the total weight (a milk fat content of not less than 2% of the total weight), and a moisture content of not more than 3% of the total weight (excluding those falling under the category of chocolate dough)), chocolate confectionery, “quasi chocolate confectionery” (quasi chocolate confectionery refers to a chocolate processed product with the quasi-chocolate dough content of less than 60% of the total weight), “Nama-Chocolate” (“Nama-Chocolate” refers to a dough with a chocolate dough content of not less than 60% of the total weight, a cream content of not less than 10% of the total weight, and a moisture content of not less than 10% of the total weight), and chocolate-using food items.

The second food item 13 herein referred to as a “food item containing fat and oil” may include fat and oil itself such as fat and oil derived from a vegetable source such as palm, coconut, soybean, corn, rapeseed, sunflower, cotton seed, cacao (cocoa butter), shea, or rice, animal fat and oil such as butter, cream, or lard, edible refined and processed fat and oil, or margarine. As the second food item 13, the above-mentioned chocolates and fats and oils may be used singly or in combination of two or more food items appropriately selected therefrom.

The caramel portion 15, which will be described later, is a heated product of sugar obtained by heating sugar sprinkled on the second food item 13. Here, the sugar is not particularly limited, and examples thereof may include: so-called sucrose such as refined sugar, (e.g., granulated sugar, white soft sugar, white crystal sugar, brown soft sugar, light brown crystal sugar, powdered sugar, cube sugar, and rock sugar) and unrefined sugar (e.g., black sugar, Wasanbon (refined Japanese sugar), maple sugar, and casonade); and saccharides such as glucose, fructose, xylose, and trehalose. These sugars may be used in combination as appropriate. The surface temperature during heating is preferably 100° C. to 350° C., and more preferably 150° C. to 300° C. Note that the above-described heated product may be obtained by only caramelization or by caramelization and Maillard reaction that occur at the same time. Alternatively, the heated product may be obtained by only Maillard reaction without caramelization.

The process of manufacturing the food item 1 will be described. Particularly when the food item 1 is contained in a container, the first food item 11 is first charged into a predetermined container 2, and then the second food item 13 is placed so as to coat at least part of the surface of the first food item. At this time, the second food item 13 in a liquid state may be poured onto the first food item 11 contained in the container 2, or the second food item 13 in a molded solid state may be put on the surface of the first food item 11. The thickness of the second food item 13 is preferably 0.8 mm to 7.0 mm, and more preferably 1.0 mm to 5.0 mm.

After the first food item 11 is charged and then the second food item 13 is placed so as to coat the first food item 11 in such a manner as described above, sugar is sprinkled on the surface of the second food item 13 and heated. The amount of the sugar is preferably 0.02 g/cm² to 0.20 g/cm², and more preferably 0.04 g/cm² to 0.16 g/cm². The sugar attached to the surface of the second food item 13 is caramelized by heating and fixed so that the caramel portion 15 is formed.

A means for the heating is not particularly limited. As is generally known, the sugar may be directly exposed to flame with a burner or the like. Alternatively, various heaters such as a halogen heater and a near-infrared heater may be appropriately used.

The caramel portion 15 shown in FIG. 1 is clearly separated from the second food item 13, but may not be clearly separated from the second food item 13 because part of the second food item 13 is practically melted by heating for caramelization so that the second food item 13 melted by heating and the melted sugar are mixed and then fixed by cooling.

In the case of a conventional general food item with caramelized surface such as a confection, a caramel portion 15 is obtained by heating sugar directly sprinkled on a food item herein referred to as the first food item 11. The caramel portion 15 of such a conventional food item is in direct contact with the first food item 11 and therefore easily absorbs moisture originally contained in the first food item 11, so that its good crispy texture is quickly lost.

However, in the present invention, the second food item 13 is interposed between the first food item 11 and the caramel portion 15, and therefore the caramel portion 15 is less likely to absorb moisture from the first food item 11. Further, oil contained in the second food item 13 further prevents the caramel portion 15 from absorbing moisture. As a result, the good crispy texture of surface of the food item achieved by caramelization can be maintained for a long period of time. In the present invention, how the second food item 13 is placed on the first food item 11 is not particularly limited. For example, there may be a method in which the second food item 13 previously prepared may be placed on the first food item 11 prepared after the second food item 13 has been prepared. Also when the second food item 13 is placed on the first food item 11 in this way, the crispy texture of the caramel portion 15 can be achieved.

When the first food item 11 is, for example, a food item having a low melting point, such as sherbet, heat generated by heating for caramelization is not directly conducted to the first food item 11 due to the interposition of a layer of the second food item 13, and therefore the first food item 11 is hard to melt. This contributes to the quality control of the first food item 11.

### Example 1

<Comparison 1>

Hereinbelow, food items contained in containers were actually manufactured in the following manner and stored under certain conditions by way of example.

### Food Item of Example 1

First food item: ice cream

Second food item: chocolate-using food item

Storage environment: freezer (−20° C. or lower (set at −24° C.) Food Item of Comparative Example 1

First food item: ice cream

Second food item: none

Storage environment: freezer (−20° C. or lower (set at −24° C.)

The ice cream used as the first food item in Example 1 and the ice cream used as the first food item in Comparative Example 1 are the same, and the storage environment in Example 1 and the storage environment in Comparative Example 1 are the same.

The ice cream used as the first food item 11 in Example 1 and Comparative Example 1 had a milk solids content of 15.0% or more (milk fat content: 8.0% or more). The chocolate-using food item used in Example 1 had a vegetable fat and oil content of 55.5% and a cocoa butter content of 2.2%, and further appropriately contained whole milk powder, cream powder, sugar, lactose, etc.

The food item of Example 1 was manufactured by charging ice cream into a container, pouring a chocolate-using food item onto the surface of the ice cream so that the surface of the ice cream was entirely coated with the chocolate-using food item having a thickness of about 1 mm, sprinkling granulated sugar on the chocolate-using food item, and baking the granulated sugar with a burner for caramelization.

On the other hand, the food item of Comparative Example 1 was manufactured in the same manner as general ice cream contained in a container by charging ice cream into a container, sprinkling granulated sugar directly on the surface of the ice cream, and baking the granulated sugar with a burner for caramelization.

The results of comparison are shown in the following Table 1. Table 1 shows the results of a sensory evaluation performed by tasting by a total of seven persons to evaluate with time how the crispy texture of the surface caramel portion was maintained according to the following three criteria: “3. The crispy texture was well maintained.”, “2. The crispy texture was maintained to some extent.”, and “1. The crispy texture was lost.”.

TABLE 1

| | Samples | | | |
|---|---|---|---|---|
| | Food Item of Comparative | | | |
| Elapsed time | Example 1 | | Food Item of Example 1 | |
| after baking | Result | Comment | Result | Comment |
| After 2 hours | 2 | The crispy texture | 3 | The crispy texture |
| | | was maintained. | | was maintained. |
| After 6 hours | 2 | The crispy texture | 3 | The crispy texture |
| | | was maintained. | | was maintained. |
| After 1 day | 2 | The crispy texture | 3 | The crispy texture |
| | | was maintained. | | was maintained. |
| After 2 days | 2 | The crispy texture | 3 | The crispy texture |
| | | was maintained. | | was maintained. |
| After 1 week | 1 | The crispy texture | 3 | The crispy texture |
| | | achieved by | | was maintained. |
| | | caramelization was | | |
| | | lost. Only the grainy | | |
| | | texture of sugar | | |
| | | remaining unmelted | | |
| | | during baking | | |
| | | remained. | | |
| After 2 weeks | 1 | The crispy texture | 3 | The crispy texture |
| | | achieved by | | was maintained. |
| | | caramelization was | | |
| | | lost. Only the grainy | | |
| | | texture of sugar | | |
| | | remaining unmelted | | |
| | | during baking | | |
| | | remained. | | |
| After about 3 | — | | 3 | The crispy texture |
| weeks | | | | was maintained. |
| (After 23 days) | | | | |
| After about 2 | — | | 2 | The surface caramel |
| months | | | | portion was slightly |
| (After 70 days) | | | | sticky but its crispy |
| | | | | texture was |
| | | | | maintained. |
| After about 3 | — | | 2 | The surface caramel |
| months | | | | portion was slightly |
| (After 90 days) | | | | sticky but its crispy |
| | | | | texture was |
| | | | | maintained. |

As shown in Table 1, in the case of the food item of Example 1, the crispy texture of the surface caramel portion was well maintained even after a lapse of about three weeks, and was maintained to some extent even after a lapse of about three months. Further, the surface caramel portion of the food item of Example 1 was very crispy even just after caramelization performed by baking (e.g., after two hours from baking). Therefore, the food item of Example 1 can give a more crispy texture as compared with the food item of Comparative Example 1 using a conventional method in which sugar is directly sprinkled on the surface of ice cream and baked for caramelization.

### Example 2

<Comparison 2>

Hereinbelow, Comparison 2 will be described.

### Food Item of Example 2

First food item: pudding

Second food item: chocolate-using food item

Storage environment: Refrigerator (10° C. or lower)

### Food Item of Comparative Example 2

First food item: pudding

Second food item: none

Storage environment: Refrigerator (10° C. or lower)

Note that the pudding used as the first food item in Example 2 and the pudding used as the first food item in Comparative Example 2 are the same, and the storage environment in Example 2 and the storage environment in Comparative Example 2 are the same.

The pudding used as the first food item in Example 2 and Comparative Example 2 is not limited by its components, composition, and manufacturing method and is an already-known one. Further, the composition of the chocolate-using food item used in Example 2 is the same as that of the chocolate-using food item used in the above-described Example 1.

The food item of Example 2 was manufactured in the following manner. A liquid pudding mix obtained in such a manner as described above was charged into a container. After the liquid pudding mix set, a chocolate-using food item was poured onto the pudding to have a thickness of about 1 mm. Then, granulated sugar was sprinkled on the chocolate and baked with a halogen heater for caramelization.

On the other hand, the food item of Comparative Example 2 was manufactured in the following manner. A liquid pudding mix obtained in such a manner as described above was charged into a container. After the liquid pudding mix set, granulated sugar was sprinkled on the surface of the pudding and baked with a halogen heater for caramelization.

As a result of Comparison 2, the caramel portion of Comparative Example 2 almost completely lost its crispy texture in about half a day (about 12 hours), and was then turned to almost a liquid state after a lapse of one day and therefore completely lost its crispy texture.

The food item of Example 2 was not subjected to a long-term test performed in Comparison 1, but maintained its crispy texture even after a lapse of at least 3 days from caramelization.

The present invention is not limited to the above examples. Although the food items contained in containers have been described above, the present invention is not limited to such food items contained in containers. For example, the surface (part or all of the surface) of the first food item 11 formed into a predetermined shape without using the container 2 may be coated with the second food item 13. Then, sugar is attached to the surface of the second food item 13 and then caramelized. That is, the present invention can be applied also to food items not contained in the containers 2, such as so-called ice cream bars.

Further, the first food item 11 or the second food item 13 may be mixed with nuts, if necessary. Further, the food item according to the present invention may be wrapped with an outer edible part or may be sandwiched between outer edible parts. Examples of the outer edible part may include monaka wafers, cones, wafers, and cookies. The food item according to the present invention makes it possible to prevent such monaka wafers or cones from absorbing moisture, and therefore the crispy texture of monaka wafers or cones can be maintained.

As described above, the thickness of the layer of the second food item 13 can be appropriately determined from the viewpoint of the amount and properties of the first food item 11. However, the influence of the second food item 13 on the taste and texture of the first food item 11 as a main component can be reduced by reducing the thickness of the second food item 13.

Further, as described above, the second food item 13 is melted and mixed with surface sugar by heating. Therefore, depending on the type of the second food item 13, a unique and original flavor can further be added in addition to good texture and flavor of caramel itself.

### REFERENCE SIGNS LIST

1 food item
2 container
11 first food item
13 second food item
15 caramel portion

What is claimed is:

1. A food item comprising:
a first food item being at least one type of food item selected from a food item group consisting of pudding, crème brulee, custard pudding, ice cream, cake, iced milk having a milk solids content of at least 10% and a milk fat content of at least 3%, lacto ice having a milk solids content of at least 3%, sherbet, cheese, yogurt, pasta, and meat,
a second food item being at least one type of food item selected from a food item group consisting of chocolate, quasi chocolate, chocolate confectionery, quasi chocolate confectionery, Nama-Chocolate, and food containing cocoa butter, fat, and oil,
the second food item is arranged so as to coat the surface of the first food item,
sugar is placed on the surface of the second food item opposite to the first food item,
then, the surface side of the second food item opposite to the first food is heated together with the sugar,
the heated product containing the melted sugar by heating is then solidified by cooling.

2. The food item according to claim 1, wherein at least part of the surface of the first food item is coated with the second food item.

3. The food item according to claim 1, wherein:
the first food item is filled in a container having an opening;
the second food item is placed so as to coat the surface of the first food item filled in the container, the surface of the first food item being located on an opening side of the container; and
the heated product containing sugar solidified coats at least a portion of a surface of the layer of the second food item, the surface of the second food item being located on the opening side of the container.

4. A method for manufacturing a food item, the method comprising:
coating at least a portion of a surface of a first food item with a second food item, wherein:
the first food item is at least one type of food item selected from a food item group consisting of pudding, crème brulee, custard pudding, ice cream, cake, iced milk having a milk solids content of at least 10% and a milk fat content of at least 3%, lacto ice having a milk solids content of at least 3%, sherbet, cheese, yogurt, pasta, and meat; and
the second food item is at least one type of food item selected from a food item group consisting of chocolate, quasi chocolate, chocolate confectionery, quasi chocolate confectionery, Nama-Chocolate, and food containing cocoa butter, fat, and oil,
placing sugar on a surface of the second food item opposite to the first food item,
then, heating the surface side of the second food item opposite to the first food item together with the sugar to melt the sugar,
then, cooling the heated product containing the melted sugar to solidify the heated product containing the melted sugar.

5. The method for manufacturing the food item according to claim 4, wherein heating the surface side of the second food item opposite to the first food item together to melt the sugar causes caramelization of the sugar.

6. The method for manufacturing the food item according to claim 4, wherein, when the at least a portion of a surface of the first food item is coated with the second food item, the second food item has a thickness of between 0.8 mm and 7.0 mm.

7. The method for manufacturing the food item according to claim 6, wherein, when the at least a portion of a surface of the first food item is coated with the second food item, the second food item has a thickness of between 1.0 mm and 5.0 mm.

8. The method for manufacturing the food item according to claim 6, wherein, as a result of heating the surface side of the second food item opposite to the first food item together with the sugar to melt the sugar, at least a portion of the second food item and at least some of the sugar are mixed and then fixed when the heated product containing the melted sugar is solidified.

9. A method for manufacturing a food item, the method comprising:
coating at least a portion of a surface of a first food item with a second food item, wherein:
the first food item is at least one type of food item selected from a food item group consisting of pudding, crème brulee, custard pudding, ice cream, cake, iced milk having a milk solids content of at least 10% and a milk fat content of at least 3%, lacto ice having a milk solids content of at least 3%, sherbet, cheese, yogurt, pasta, and meat; and
the second food item contains fat and oil,
placing sugar on a surface of the second food item opposite to the first food item;
then, heating the surface side of the second food item opposite to the first food item together with the sugar to melt the sugar; and
then, cooling the heated product containing the melted sugar to solidify the heated product containing the melted sugar.

10. The method for manufacturing the food item according to claim 9, wherein, when the at least a portion of a surface of the first food item is coated with the second food item, the second food item has a thickness of between 0.8 mm and 7.0 mm.
